(19) United States
(12) Patent Application Publication
(10) Pub. No.: US 2006/0139805 A1
(43) Pub. Date: Jun. 29, 2006

(54) Magnetic disk and magnetic disk apparatus provided with the same

(75) Inventors: Manabu Akamatsu, Ome-shi (JP); Kotaro Yamamoto, Tachikawa-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/315,305

(22) Filed: Dec. 23, 2005

(30) Foreign Application Priority Data
Dec. 28, 2004 (JP) 2004-380302

(51) Int. Cl. G11B 5/82

(52) U.S. Cl. 360/135

(57) ABSTRACT

A magnetic disk of a magnetic disk apparatus includes a flat disk-shaped substrate having a recording region formed on at least one of front and back surfaces and patterned depending on the presence of a magnetic material. The recording region includes a data recording region, an annular landing region formed continuously to the data recording region, and a plurality of servo regions. The data recording region has a plurality of magnetic tracks extending in a circumferential direction of the substrate, respectively, and provided in the radial direction of the substrate at a predetermined pitch. The recording region includes a plurality of recognition tracks extending in the circumferential direction of the substrate, respectively and arranged in the radial direction of the substrate concentrically with the magnetic tracks at a visually recognizable pitch larger than the pitch of the magnetic tracks of the data recording region.

### CROSS-REFERENCE TO RELATED APPLICATIONS

This application is based upon and claims the benefit of priority from prior Japanese Patent Application No. 2004-380302, filed Dec. 28, 2004, the entire contents of which are incorporated herein by reference.

### BACKGROUND OF THE INVENTION

1. Field of the Invention

This invention relates to a magnetic disk and a magnetic disk apparatus provided with the same.

2. Description of the Related Art

In recent years, magnetic disk apparatuses have been widely used as external recording devices of computers and image recording devices. In general, a magnetic disk apparatus comprises a case in the form of a rectangular box. The case contains a magnetic disk for use as a magnetic recording medium, a spindle motor that supports and rotates the disk, magnetic heads for writing and reading information to and from the disk, and a head actuator that supports the heads for movement with respect to the disk. The case further contains a voice coil motor that rotates and positions the head actuator, a board unit that has a head IC and the like, etc. A printed circuit board for controlling the respective operations of the spindle motor, voice coil motor, and magnetic heads through the board unit is screwed to the outer surface of the case.

Further miniaturization of magnetic disk apparatuses has recently been advanced so that they can be used as recording devices for a wider variety of electronic apparatuses, or smaller-sized electronic apparatuses in particular. Accordingly, magnetic disks are expected to be further reduced in size and enhanced in recording density. Proposed in Jpn. Pat. Appln. KOKAI Publication No. 2003-22634, for example, is a magnetic disk of the so-called discrete-track-recording (DTR) type, as a magnetic disk that is small-sized and ensures high-density recording. This DTR magnetic disk has rugged surfaces, and a magnetic material that can record data is formed on its projections. The surfaces of the magnetic disk are rugged and previously formed having patterned regions, including a servo region to which servo data are recorded and a data region to which a user can record data. A large number of projections or magnetic tracks are formed on the data region.

According to the DTR magnetic disk described above, the adjacent magnetic tracks are divided by recesses, so that crosstalk between the magnetic tracks can be prevented to ensure high-density recording. In the DTR magnetic disk, the magnetic tracks are distributed at a high density such that their pitch is not lower than the visible light wavelength. Therefore, rainbows such as interference fringes cannot be seen, so that a recording surface of the magnetic disk cannot be recognized visually.

On the other hand, the magnetic disk is mounted on the spindle motor of the magnetic disk apparatus and rotated at high speed. Accordingly, to execute accurate recording and reproduction, the magnetic tracks of the magnetic disk must be concentrically positioned at the center of rotation of the spindle motor. However, as described above, since it is impossible to visually recognize the magnetic tracks and the recording surface of the magnetic disk, it is difficult to measure the eccentricity of the magnetic tracks to the spindle motor. As a result, it is difficult to adjust the position of the magnetic disk to minimize the eccentricity of the magnetic tracks, which is an obstacle for improvement of the positioning accuracy of the magnetic heads to the magnetic disk and execution of access at high speed.

### BRIEF SUMMARY OF THE INVENTION

The present invention is contrived in consideration of the above circumstances, and its object is to provide a magnetic disk which permits the eccentricity of magnetic tracks to be easily measured visually and the like so that the positioning accuracy of magnetic heads can be improved, access can be executed at high speed, and a recording density can be improved, and to provide a magnetic disk apparatus including the magnetic disk.

According to an aspect of the invention, there is provided a magnetic disk comprising: a flat disk-shaped substrate having a front surface, a back surface, and a center hole; and a recording region formed on at least one of the front and back surfaces excluding an annular edge portion located around an outer peripheral edge portion of the substrate and patterned depending on the presence of a magnetic material,

the recording region including a data recording region formed between the center hole and the edge portion of the substrate, an annular landing region formed continuously to the data recording region around the outer periphery of the data recording region, and a plurality of servo regions; and the data recording region having a plurality of magnetic tracks extending in a circumferential direction of the substrate, respectively, and provided in the radial direction of the substrate at a predetermined pitch, and the recording region including a plurality of recognition tracks extending in the circumferential direction of the substrate, respectively and arranged in the radial direction of the substrate concentrically with the magnetic tracks at a visually recognizable pitch larger than the pitch of the magnetic tracks of the data recording region.

According to another aspect of the invention, there is provided a magnetic disk apparatus comprising: a magnetic disk according to claim 1; a drive unit which supports the magnetic disk and rotates it at a predetermined speed; a head which performs information processing for the magnetic disk; and a head actuator which moves the head in a radial direction with respect to the magnetic disk.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are plan views showing a front surface pattern and a back surface pattern of a magnetic disk according to an embodiment of the present invention;

FIG. 2 is an enlarged perspective view partly in cross section showing a data recording region of the magnetic disk;

FIG. 3 is a plan view of a data recording region, servo regions, and a landing region of the magnetic disk;

FIG. 4 is an enlarged plan view schematically showing the landing region;

FIG. 5 is a view schematically showing the servo regions of the magnetic disk;

FIG. 6 is a view schematically showing the optical reflectance of a data recording region and a servo region pattern of the magnetic disk;

FIG. 7 is an exploded perspective view showing a hard disk drive (hereinafter referred to as an HDD) according to an embodiment of the present invention;

FIG. 8 is a block diagram schematically showing an arrangement of the HDD;

FIG. 9 is a side elevational view schematically showing an inspection device for detecting the eccentricity of the magnetic disk; and

FIG. 10 is a plan view schematically showing an inspection process using the inspection device.

### DETAILED DESCRIPTION OF THE INVENTION

A magnetic disk according to an embodiment of this invention will now be described in detail with reference to the accompanying drawings.

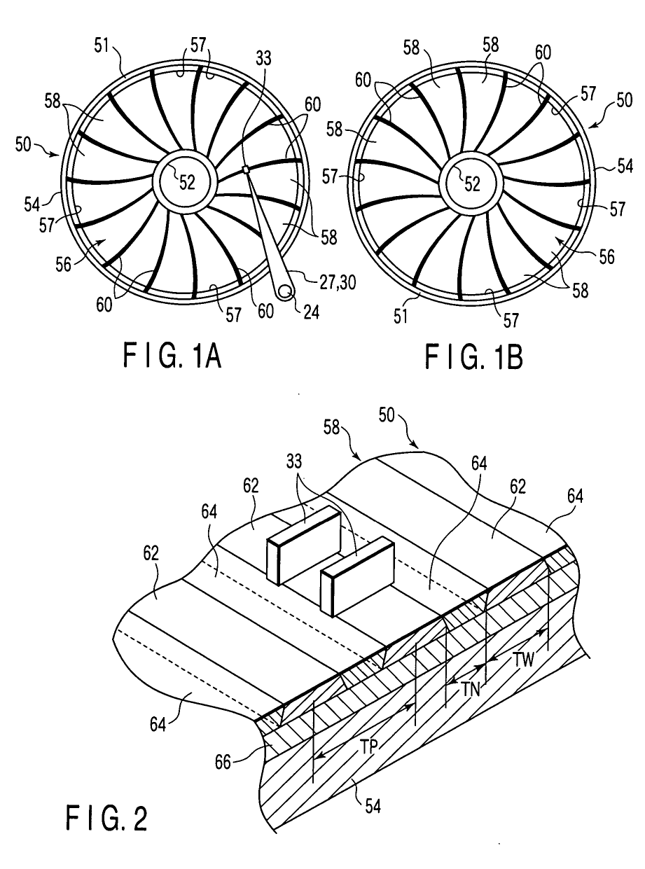

As shown in FIGS. 1A, 1B and 2, a magnetic disk 50 according to the present embodiment comprises a substrate 54 in the form of a flat disk having a center hole 52 and recording layers 56 formed on at least one surface of the substrate (front and back surfaces of the substrate in this case). Each of the recording layers 56, which constitutes a recording region, has the form of a ring that coaxially covers all the area of the substrate 54 except its inner and outer peripheral edge portions. Each recording layer 56 is formed of a ferromagnetic material, e.g., CoCrPt, and is patterned. Those regions of the layer which have no magnetic material are filled with a nonmagnetic material, e.g., SiO₂. Thus, the resulting magnetic disk has a leveled surface and serves for perpendicular magnetic recording.

The magnetic disk 50 is formed as a DTR medium. FIG. 1A shows a pattern of the recording layer 56 on the front side of the disk 50. FIG. 1B shows a pattern of the layer 56 on the back side of the disk 50. Roughly speaking, each pattern of the recording layer 56 includes a data recording region 58, a landing region 57, and a plurality of servo regions 60.

As shown in FIG. 2, the substrate 54 is formed of glass, for example, and has a base layer (SUL) 66 on each of its front and back surfaces. The substrate 54 may be formed of aluminum in place of glass. Patterns of the data recording region 58 and the servo regions 60 are formed on each base layer 66.

The data recording region 58 forms a recording region where user data are recorded and reproduced by a head of a magnetic disk apparatus (mentioned later), and the pattern of the data recording region 58 is composed of projections of a magnetic material on the surface of the substrate 54. More specifically, the data recording region 58 has a plurality of circular ring-shaped magnetic tracks 62 that serve as perpendicular recording layers of a ferromagnetic material (CoCrPt). These magnetic tracks 62 are arranged substantially coaxially with the center hole 52 and side by side at predetermined periods or track pitches Tp in the radial direction of the substrate 54.

The magnetic tracks 62 that adjoin in the radial direction of the substrate 54 are divided by nonmagnetic guard belt portions 64 in the form of recesses to which data cannot be recorded. According to the present embodiment, SiO₂ is implanted in the nonmagnetic guard belt portions 64 in order to level the disk surface. Further, a thin carbon protective film is formed on the magnetic disk surface, and it is coated with a lubricant. A protective layer may be formed directly on the irregular surface without embedding the guard belt portions 64 in the surface.

A radial width Tw of each magnetic track 62 that extends in the radial direction of the substrate 54 is larger than a width TN of each nonmagnetic guard belt portion 64. In the present embodiment, the ratio of the radial width of each magnetic track 62 to that of each nonmagnetic guard belt portion 64 is 2:1, and the pattern of the data recording region 58 has a magnetic occupancy of 67%. Since the data recording region 58 has a high track density exceeding 120 kTPI, for example, the radial pattern period (track pitch) Tp is shorter than a visible light wavelength. Thus, a rainbow pattern that is formed by light diffraction by the magnetic tracks 62 cannot be visually recognized in the magnetic disk 50.

As shown in FIGS. 1A, 1B, 3, and 4, the landing region 57 is formed in an annular shape and continuously disposed around the outer periphery of the data recording region 58 on the inside of the edge portion 51. The landing region 57 forms a region in which the heads are loaded on and unloaded from the magnetic disk 50 in the magnetic disk apparatus described later.

The pattern of the landing region 57 is composed essentially of a convex portion formed of a magnetic substance on the surface of the substrate 54. More specifically, the landing region 57 is formed of a ferromagnetic material (CoCrPt) likewise the magnetic tracks 62 of the data recording region 58 and has a plurality of annular magnetic tracks 70 that are concentric with the magnetic tracks 62 of the data recording region 58.

A plurality of tracks of the magnetic tracks 70 constitute recognition tracks 70A. The recognition tracks 70A is formed to the entire region or a part of the landing region 57 and arranged at a predetermined pitch TLp wider than the radial pitch Tp of the magnetic tracks 62 of the data recording region 58. The radial width of a recognition region 59 formed by the plurality of recognition tracks 70A is formed to a width that can be visually recognized, for example, 50 μm or more.

Recognition tracks 70A disposed adjacent to each other in the radial direction are separated from each other by nonmagnetic guard belts 72 each composed essentially of a concave portion to which data cannot be recorded. According to the present embodiment, SiO₂ is buried in the respective nonmagnetic guard belts 72 to make the disk surface flat.

The radial width TLw of the respective recognition tracks 70A disposed in the radial direction of the substrate 54 is set equal to, for example, the track width TW of the magnetic tracks 62. However, TW need not be necessarily equal to TLw because a rainbow pattern to be generated is determined by the ratio of the width TLw of the recognition tracks to the track pitch TLp of the recognition tracks 70A.

When the track pitch TLp of the recognition tracks 70A is formed to, for example, 400 nm, since the diffracted light obtained from light having a wave length of 500 nm and an incident angle of 30° appears at a position having a reflection angle of 48.6°, it can be visually recognized. As described above, the recognition tracks 70A, which are formed in a low density and can be visually recognized, can be used as a pattern for measuring the eccentricity of the magnetic track 62 of the data recording region 58.

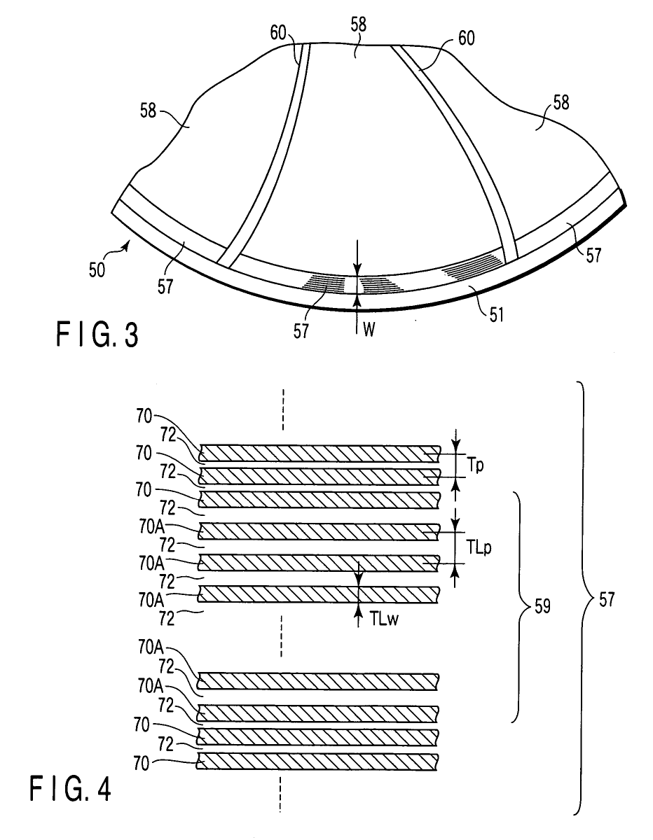

As shown in FIGS. 1A and 1B and 3, the ring-shaped magnetic tracks 62 formed in the data recording region 58 and the ring-shaped magnetic tracks 70 formed in the landing region 57 are sectored in the circumferential direction of the substrate 54 by the plurality of servo region patterns 60. In these drawings, the data recording region 58 and the landing region 57 are shown to be divided in fifteen sectors. Actually, however, the data recording region 58 is divided in 100 servo sectors or more.

Each servo region 60 is a prebid region in which necessary information for positioning the head of the magnetic disk apparatus is implanted in a magnetic or nonmagnetic manner. The pattern of each servo region 60 has an arcuate shape that coincides with a movement path of the head. Further, each servo region 60 has a circumferentially extended pattern such that its circumferential length along the circumference of the substrate 54 increases in proportion to the radial position on the substrate, that is, a region on the outer peripheral side of the substrate is longer. The servo regions 60 of the front-side recording layer 56 of the substrate 54 and the servo regions 60 of the back-side recording layer 56 are arranged in different orders in the circumferential direction. For example, the patterns on the front side are arranged in the counterclockwise direction, and those on the back side in the clockwise direction. Thus, the recording regions of the magnetic disk 50 have patterned magnetic material shapes, one on the front side and another on the back.

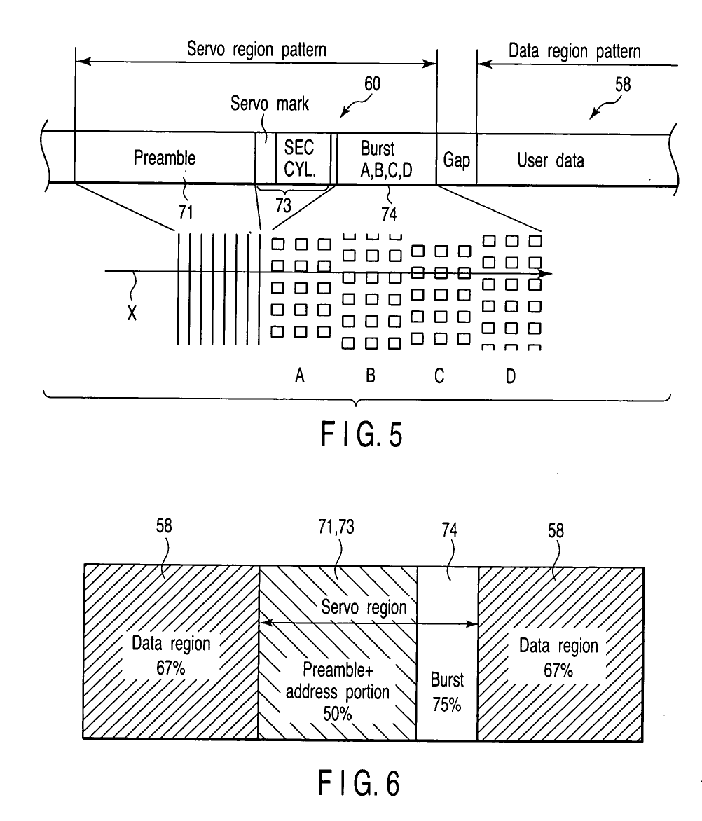

One of the servo regions 60 will now be described in detail with reference to FIG. 5.

FIG. 5 shows the servo region 60 that is provided on the front side of the magnetic disk 50. This servo region 60 is a pattern in a position where the head passes from left to right of FIG. 5 in a passing direction X when the magnetic disk 50 is set in a drive. If the pattern 60 is represented by an arcuate servo region pattern shape, circular arcs on the outer and inner peripheral sides are situated on the left- and right-hand sides, respectively, of FIG. 5. The data recording region 58 is located on either side of the servo region 60.

Roughly speaking, the pattern of the servo region 60 has a preamble portion 70, an address portion 73, and a burst portion 74 for deviation detection. Like the data recording region 58, it is composed of magnetic patterns formed of ferromagnetic projections and nonmagnetic patterns formed of recesses between the magnetic patterns.

The preamble portion 70 is provided to perform PLL processing and AGC processing. In the PLL processing, clocks for servo signal reproduction are synchronized with time delays that are caused by rotation eccentricity or the like of the magnetic disk 50. The AGC processing serves to maintain an appropriate signal reproduction amplitude. The preamble portion 70 is formed as a repetitive pattern region that is substantially radially continuous at least in the radial direction of the substrate 54 and includes magnetic and nonmagnetic portions arranged alternately in the circumferential direction of the substrate 54. The magnetic-nonmagnetic ratio of the preamble portion 70 is substantially 1:1, that is, its magnetic occupancy is about 50%. The circumferential repetition period, which varies in proportion to the radial distance, is not longer than the visible light wavelength even in an outermost peripheral portion of the substrate 54. As in the case of the data recording region, it is hard to identify the servo region by light diffraction.

In the address portion 73, a servo signal recognition code called a servo mark, sector information, cylinder information, etc. are formed in Manchester codes that are arranged at the same pitches as the circumferential pitches of the preamble portion 70. The cylinder information has a pattern such that it changes with every servo track. In order to lessen the influence of a mistake in address reading during head seek operation, therefore, the information is Manchester-encoded and recorded after code conversion is performed such that variations from adjacent tracks called Gray codes are minimal. The magnetic occupancy of the address portion 73 is about 50%.

The burst portion 74 is an off-track detection region for detecting an off-track deviation from an on-track state of a cylinder address. It is formed with four marks or bursts A, B, C and D whose pattern phases are shifted in the radial direction. Each burst has a plurality of marks that are arranged at the same pitch periods as the preamble portion in the circumferential direction. A radial period is proportional to the change period of an address pattern, that is, to a servo track period. In the present embodiment, each burst is formed for 10 periods in the circumferential direction. In the radial direction, its patterns are repeated with a period twice as long as the servo track period. The magnetic occupancy of A, B, C and D burst patterns is about 75%.

Basically, each mark is designed for a rectangle, or more strictly, a parallelogram based on a skew angle at the time of head access. Depending on the machining performance, such as the stamper working accuracy, transfer formation, etc., however, the marks are somewhat rounded. Further, the marks are formed as nonmagnetic portions.

A detailed description of the principle of position detection based on the burst portion 74 is omitted. The off-track deviation is calculated by arithmetically processing an average amplitude value of reproduction signals for the burst portions A, B, C and D. Although the A, B, C and D burst patterns are used in the present embodiment, they may be replaced with conventional phase difference servo patterns or the like that are arranged as off-track detecting means. However, the magnetic occupancy of the phase difference servo patterns is about 50%.

In the case of a magnetic disk that has a low-density pattern with a track pitch of 400 nm or more, optical diffraction is caused by irregular track patterns if the substrate is roughened so that whole surface of a magnetic layer is irregular. Thus, reflected light from the data region pattern can be visually recognized as a rainbow-like diffracted light. In this case, the arcuate servo region pattern shape can be visually recognized with ease.

In the case of a magnetic disk that has a track pitch shorter enough than the visible light wavelength, optical diffraction never occurs, so that it is hard to recognize a rainbow pattern. If the whole surface of the magnetic layer is made irregular, therefore, it is difficult visually to recognize the servo and data regions.

If the recording layers have magnetic and nonmagnetic patterns, as in the magnetic disk 50 according to the present embodiment, on the other hand, the lower the magnetic occupancy of the patterns, the lower the intensity of reflected light is. This is because magnetic and nonmagnetic portions have somewhat different reflection factors. Also, this characteristic is attributable to influences of multi-path reflection from the embedded nonmagnetic portion and absorbance.

Thus, even in the case of a high-density pattern from which optical diffraction cannot be expected, the arcuate tracks of the servo regions 60 can be optically discriminated by a difference in reflected light intensity. This can be done in a manner such that a certain or greater difference in magnetic occupancy is provided between the data recording region 58 and the servo regions 60.

If there is a difference of about 10% in optical reflection factor, the patterns can be discriminated satisfactorily. In the present embodiment, the magnetic occupancy of the data recording region 58 is about 67%, while the respective magnetic occupancies of the preamble portion 70 and the address portion 73 of each servo region 60 are 50%. Thus, the difference in reflection factor from the data recording region is great enough for the optical recognition of the servo regions.

FIG. 6 shows an optical microscope image near the servo region 60. The magnetic tracks 62, fine patterns, etc. are invisible. The preamble portion 70 and the address portion 73 of the servo region 60 can be optically recognized even if they are darker and denser than the data recording region 58. Arcuate servo patterns can be discriminated more clearly through a polarizing filter, for example.

As mentioned before, each servo region 60 is substantially in the shape of a circular arc. The pattern shape of the servo region is effective in discriminating the front and back of the magnetic disk 50. If the servo region pattern is perfectly radial, it is symmetrical. Although the servo region patterns on each disk surface can be discriminated, therefore, the side, front or back, on which the patterns are formed cannot be identified. Since the servo regions 60 are formed in the head passing direction X, as shown in FIG. 5, servo information cannot be easily identified if the side of the magnetic disk is mistaken. In an assembly process in which the magnetic disk 50 having the servo regions 60 previously formed thereon is incorporated in the magnetic disk apparatus as the drive, it is essential to set the disk 50 without mistaking its side. Thus, it is effective to form the arcuate servo region patterns by which the side, front or back, of the magnetic disk 50 can be recognized with ease.

Besides, the movement path of the head of the magnetic disk apparatus is an arcuate path around a rotary drive mechanism, which will be mentioned later. Preferably, therefore, the servo regions 60 of the magnetic disk 50 are arcuate patterns that are substantially coincident with the head movement path.

The following is a brief description of a method of manufacturing the magnetic disk 50 described above. Manufacturing processes include a transfer process, a magnetic processing process, and a finishing process. First, a method of manufacturing a stamper that constitutes a base of a pattern used in the transfer process will be described.

A method of manufacturing a stamper can be divided into steps of drawing, development, electroforming, and finishing. In the pattern drawing, a part of the magnetic disk to be demagnetized is exposed for drawing from its inner periphery to outer periphery on a resist-coated matrix by using an electron beam exposure unit of a matrix-rotation type. The resulting structure is subjected to development, RIE, etc. to form a matrix with irregular patterns. After this matrix is treated for electrical conductibility, its surface is electroformed with nickel. Subsequently, the nickel is separated from the matrix, and a disk-shaped stamper of nickel is formed by punching for inside and outside diameters. The stamper has projections on those parts which are to be demagnetized. Stampers for the front and back surfaces of the magnetic disk are formed individually.

In the transfer process, the irregularities of the stamper are transferred to the magnetic disk by the imprint lithography using an imprinter of a synchronous double-sided transfer type. More specifically, base layers are first formed individually on the opposite sides of the substrate 54 that is formed of glass or silicon, and magnetic layers of a ferromagnetic material are further formed overlapping the base layers.

A resist is applied to both surfaces of the perpendicular-recording magnetic disk by spin coating. After the disk is baked, it is chucked by its center hole 52. For example, liquid SiO₂ (SOG) is used as the resist. In this state, the opposite sides of the magnetic disk are sandwiched between two types of stampers that are provided for the back and front surfaces, individually, whereby the whole surfaces are pressed uniformly. Thus, the irregular patterns of the stampers are transferred to the resist surface. By this transfer process, the parts to be demagnetized are formed as recesses in the resist.

Then, in the magnetic processing process, the magnetic layer surface of the parts to be demagnetized is exposed after the residual resist at the respective bottoms of the recesses of the resist is removed. At that part where the magnetic layer is to be left, the resist is formed as projections. Then, only those parts of the magnetic layer which are situated corresponding to the recesses are removed by ion milling using the resist as a guard layer, whereby the magnetic material is worked into a desired pattern.

Subsequently, SiO₂ films are formed individually to an adequate thickness on the opposite surfaces of the magnetic disk by, for example, sputtering, thereby eliminating the irregularities of the disk surfaces. By removing the SiO₂ films to the depth of the magnetic layer surfaces by back sputtering, the flat pattern magnetic disk can be obtained having the recesses filled with the nonmagnetic material.

In the final finishing process, the disk surfaces are polished further to improve the levelness, and the carbon protective film is formed thereafter. The magnetic disk according to the present embodiment is completed by further application of the lubricant.

The following is a description of a hard disk drive (HDD) as the magnetic disk apparatus that is provided with the magnetic disk 50 described above.

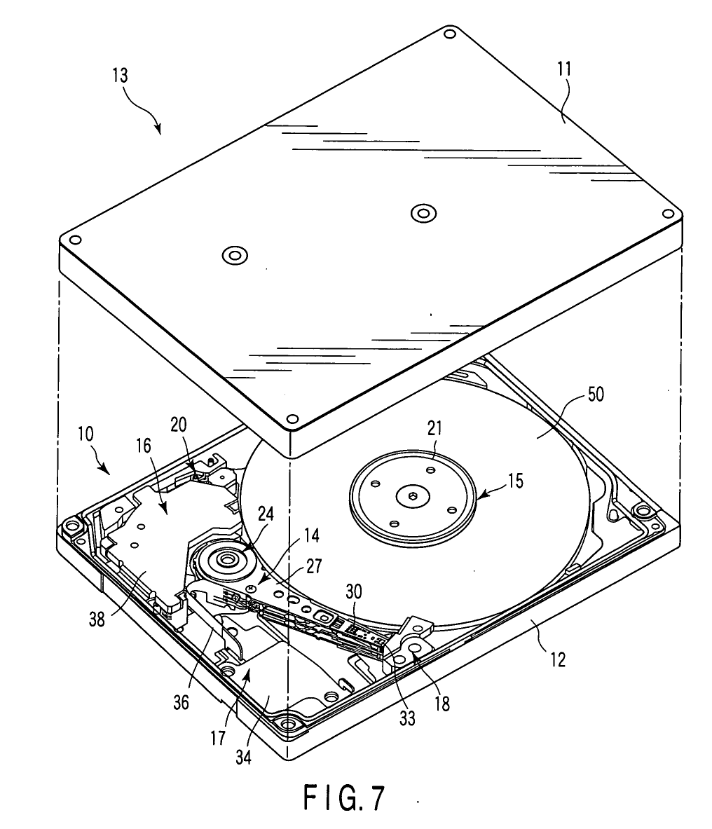

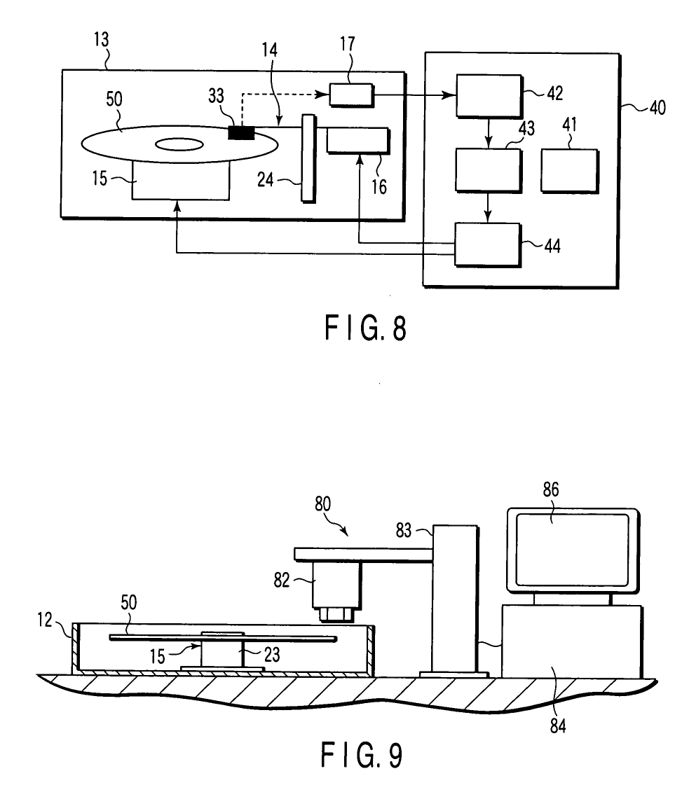

As shown in FIGS. 7 and 8, a magnetic disk apparatus 10 comprises a flat, rectangular disk enclosure 13. The enclosure 13 has a box-shaped base 12 and a top cover 11 that hermetically closes a top opening of the base 12.

The disk enclosure 13 contains the magnetic disk 50, a spindle motor 15, magnetic heads 33, and a head actuator 14. The spindle motor 15 supports and rotates the disk. The magnetic heads 33 are used to record and reproduce information to and from the disk. The head actuator 14 supports the magnetic heads for movement with respect to the magnetic disk 50. The enclosure 13 further contains a voice coil motor (hereinafter, referred to as a VCM) 16, a ramp load mechanism 18, an inertia latch mechanism 20, and a flexible printed circuit board unit (hereinafter, referred to as an FPC unit) 17. The VCM 16 rotates and positions the head actuator 14. The ramp load mechanism 18 holds the magnetic heads 33 in a position off the magnetic disk 50 when the heads are moved to the outermost periphery of the disk. The inertia latch mechanism 20 holds the head actuator 14 in a shunt position. The FPC unit 17 is mounted with circuit components, such as a preamplifier. The base 12 has a bottom wall, and the spindle motor 15, head actuator 14, VCM 16, etc. are arranged on the inner surface of the bottom wall.

As mentioned before, the magnetic disk 50 is a small-diameter patterned medium with a perpendicularly magnetized dual-film structure, both surfaces of which are processed for DTR. More specifically, the disk 50 has recording layers 56 on its front and back surfaces. It is formed having a diameter of 1.8 or 0.85 inch. The magnetic disk 50 is coaxially fitted on a hub (not shown) of the spindle motor 15 and fixed to the hub by a clamp spring 21. The magnetic disk 50 is supported and rotated at a given speed by the spindle motor 15 as a driver unit.

The head actuator 14 has a bearing portion 24 fixed on the bottom wall of the base 12, two arms 27 attached to the bearing portion, and suspensions 30 extending individually from the arms. The magnetic heads 33 are supported individually on the respective extended ends of the suspensions 30. The arms 27, suspensions 30, and heads 33 are supported for rotating motion around the bearing portion 24. The heads 33 include a down-head that faces the front-side recording layer of the magnetic disk 50 and an up-head that faces the back-side recording layer of the disk. In each magnetic head 33, a slider for use as a head body is mounted with a magnetic head element that includes a read element (GMR element) and a write element.

The VCM 16 has a voice coil 22 attached to the head actuator 14, a pair of yokes 38 fixed to the base 12 and opposed to the voice coil, and a magnet (not shown) fixed to one of the yokes. The VCM 16 generates a rotational torque around the bearing portion 24 in the arms 27 and moves the magnetic heads 33 in the radial direction of the magnetic disk 50.

The FPC unit 17 has a rectangular board body 34 that is fixed on the bottom wall of the base 12. Electronic components, connectors, etc. are mounted on the board body. The FPC unit 17 has a belt-shaped main flexible printed circuit board 36 that electrically connects the board body 34 and the head actuator 14. The magnetic heads 33 that are supported by the head actuator 14 are connected electrically to the FPC unit 17 through a relay FPC (not shown) and the main flexible printed circuit board 36.

As mentioned before, the magnetic disk 50 has the front and back sides and is set in the base 12 with the front and back sides aligned so that the head movement path of the magnetic disk apparatus is substantially coincident with the arcuate shape of the servo regions 60 of the magnetic disk. The specifications of the magnetic disk 50 fulfill outside and inside diameters, recording and reproducing characteristics, etc. that are adaptive to the magnetic disk apparatus. Each arcuate servo region 60 has its center of circular arc on the circumference of a circle that is concentric with the magnetic disk and has its radius equivalent to the distance from the rotation center of the magnetic disk to the center of the bearing portion 24 of the head actuator 14. The radius of the circular arc is equivalent to the distance from the bearing portion 24 to each magnetic head 33. In other words, each servo region 60 has the shape of a circular arc that is always substantially coincident with the head movement path even when the magnetic rotates. The radius of the circular arc of each servo region 60 is equivalent to the distance from the bearing portion 24 to each magnetic head 33. The center of the circular arc moves along a circular path that is concentric with the magnetic disk and varies in synchronism with the angle phase on the disk on which the patterns are formed. The radius of the path of the center of the circular arc is equivalent to the distance from the center of the spindle motor 15 to the center of the bearing portion 24.

A printed circuit board (hereinafter, referred to as a PCB) 40 for controlling the respective operations of the spindle motor 15, VCM 16, and magnetic heads through the FPC unit 17 is fixed to the outer surface of the bottom wall of the base 12, and faces the base bottom wall.

As shown in FIG. 8, a large number of electronic components are mounted on the PCB 40. These electronic components mainly include four system LSI's, a hard disk controller (hereinafter, referred to as a HDC) 41, a read/write channel IC 42, an MPU 43, and a motor driver IC 44. Further, the PCB 40 is mounted with a connector that can be connected to a connector on the side of the FPC unit 17 and a main connector for connecting the HDD to an electronic apparatus such as a personal computer.

The MPU 43 is a controller of a drive operating system and includes a ROM, RAM, CPU, and logic processor, which realize a positioning control system according to the present embodiment. The logic processor is an arithmetic processor composed of a hardware circuit and is used for high-speed arithmetic processing. Further, operating software (FW) is saved in the ROM, and the MPU controls the drive in accordance with this FW.

The HDC 41 is an interface section in the HDD. It exchanges information with an interface between the disk drive and a host system, e.g., a personal computer, the MPU 43, the read/write channel IC 42, and the motor driver IC 44, thereby managing the whole HDD.

The read/write channel IC 42 is a head signal processor associated with read/write operation. It is composed of a circuit that switches channels of a head amplifier IC and processes recording and reproducing signals, such as read/write signals. The motor driver IC 44 is a drive unit for the VCM 16 and the spindle motor 15. It drivingly controls the spindle motor for constant rotation and applies a VCM manipulated variable from the MPU 43 as a current value to the VCM, thereby driving the head actuator 14.

Next, a method of inspecting the eccentricity of the magnetic disk 50 in a HDD assembly process will be explained. Here, a method of measuring the eccentricity of the magnetic disk 50, in particular, the eccentricity of the magnetic tracks 62 with respect to the center of rotation of the spindle motor using the recognition tracks 70A formed to the landing region 57 will be explained.

FIG. 9 shows an inspection device 80 for detecting the eccentricity. The inspection device 80 is arranged above the HDD and includes a camera 82 for imaging the surface of the magnetic disk 50, a support table 83 which supports the camera so that its position can be adjusted, a controller 84 for processing image data imaged by the camera 82, a monitor 86 for displaying an eccentricity, and the like.

In the inspection process, first, the spindle motor 15 and other necessary parts are mounted on a base 12 of the HDD. Subsequently, the magnetic disk 50 is mounted on and tentatively fixed to a hub 23 of the spindle motor 15. As described above, the magnetic disk 50 includes the data recording region 58 on which the magnetic tracks 62 are formed, the landing region 57 on which the recognition tracks 70A are formed, and servo regions 60.

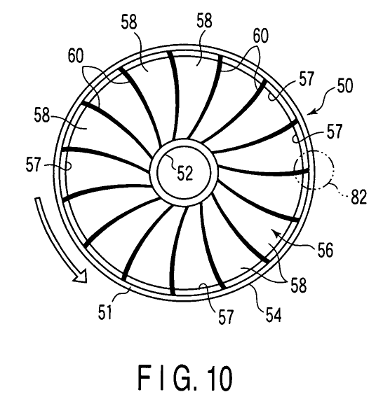

Next, as shown in FIGS. 9 and 10, the camera 82 of the inspection device 80 is arranged above the magnetic disk 50 and fixed at a position from which the landing region 57 is imaged. Then, the magnetic disk 50 is rotated once together with the hub 23 of the spindle motor 15 while imaging the recognition tracks 70A of the landing region 57 by the camera 82. At the time, when the center of rotation of the spindle motor 15 is not concentric with the center of the recognition tracks 70A formed on the magnetic disk 50 and eccentricity occurs, the patterns of the recognition tracks 70A displayed on the monitor 86 move. Subsequently, after the position of the magnetic disk 50 is adjusted so that the amount of movement of the patterns of the recognition tracks 70A is within a standard, the magnetic disk is fixed to the hub 23 of the spindle motor 15 by a clamp spring 21.

In the magnetic disk 50, the magnetic tracks 62 of the data recording region 58 are formed concentrically with the recognition tracks 70A. Accordingly, the eccentricity of the magnetic tracks 62 to the center of rotation of the spindle motor 15 can be eliminated by adjusting the position of the magnetic disk 50 so that the amount of movement of the patterns of the recognition tracks 70A, that is, the eccentricity thereof is within the standard.

The magnetic disk 50 and the HDD arranged as described above have the eccentricity measuring recognition tracks 70A which are concentrically with the magnetic tracks 62 for recording data and can be visually recognized. Accordingly, the eccentricity between the center of the magnetic tracks 62 formed on the magnetic disk and the center of rotation of the spindle motor 15 can be easily measured, thereby the magnetic disk apparatus can be assembled such that the eccentricity is reduced. With this arrangement, there can be obtained a magnetic disk and a HDD with which a positioning accuracy can be improved, access can be executed at high speed, and the density of the magnetic tracks can be increased.

Further, the recognition tracks 70A are formed in the landing region 57 which is not used for recording data. Accordingly, reduction in the recording density due to the recognition tracks 70A can be prevented. Further, according to the present embodiment, since the front and back surfaces of the magnetic disk 50 can be visually confirmed, the assembly of a disk apparatus can be easily managed in consideration of a front/back direction depending on media being supplied. Further, the servo regions are formed in an arc shape in correspondence to a head moving path, which is advantageous to prevent deterioration of seek performance and a SN ratio between the inner and outer peripheries of the disk, thereby the performance of the magnetic disk apparatus can be improved.

The present invention is not limited directly to the embodiments described above, and its components may be embodied in modified forms without departing from the scope or spirit of the invention. Further, various inventions may be made by suitably combining a plurality of components described in connection with the forgoing embodiments. For example, some of the components according to the foregoing embodiment may be omitted. Furthermore, components according to different embodiments may be combined as required.

While the recognition tracks are formed in the landing region of the magnetic disk in the embodiment described above, the present invention is by no means limited thereto, and the recording tracks may be formed in the other regions of the magnetic disk such as the data recording region, a system region, and the like. The eccentricity of the magnetic tracks can be easily detected and the position of the magnetic disk can be adjusted also in this case.

In addition to the above mentioned, the number of the magnetic disk in the HDD is not limited to one sheet and may be increased when necessary.

What is claimed is:

1. A magnetic disk comprising:
a flat disk-shaped substrate having a front surface, a back surface, and a center hole; and
a recording region formed on at least one of the front and back surfaces excluding an annular edge portion located around an outer peripheral edge portion of the substrate and patterned depending on the presence of a magnetic material,
the recording region including a data recording region formed between the center hole and the edge portion of the substrate, an annular landing region formed continuously to the data recording region around the outer periphery of the data recording region, and a plurality of servo regions; and
the data recording region having a plurality of magnetic tracks extending in a circumferential direction of the substrate, respectively, and provided in the radial direction of the substrate at a predetermined pitch, and the recording region including a plurality of recognition tracks extending in the circumferential direction of the substrate, respectively and arranged in the radial direction of the substrate concentrically with the magnetic tracks at a visually recognizable pitch larger than the pitch of the magnetic tracks of the data recording region.

2. A magnetic disk comprising:
a flat disk-shaped substrate having a front surface, a back surface, and a center hole; and
a recording region formed on at least one of the front and back surfaces excluding an annular edge portion located around an outer peripheral edge portion of the substrate and patterned depending on the presence of a magnetic material,
the recording region including a data recording region formed between the center hole and the edge portion of the substrate, an annular landing region formed continuously to the data recording region around the outer periphery of the data recording region, and a plurality of servo regions which are formed in substantially radial patterns extending from the center hole to an outer peripheral edge portion of the substrate, respectively and which divide the data recording region and the landing region into a plurality of sections, respectively in the circumferential direction of the substrate; and
the data recording region has a plurality of magnetic tracks extending in the circumferential direction of the substrate, respectively as well as formed in the radial direction of the substrate at a predetermined pitch, and the landing region including a plurality of recognition tracks extending in the circumferential direction of the substrate, respectively and arranged in the radial direction of the substrate concentrically with the magnetic tracks at a visually recognizable pitch larger than the pitch of the magnetic tracks of the data recording region.

3. The magnetic disk according to claim 2, wherein the recognition tracks of the substrate are formed in the entire region or a part of the landing region at a pitch of 400 nm or more.

4. The magnetic disk according to claim 2, wherein the data recording region includes a plurality of signal holding magnetic tracks, which are arranged at equal spaces in the radial direction of the substrate and formed in a circular ring-shaped pattern, and nonmagnetic guard belts, which are situated between the magnetic tracks adjoining in the radial direction of the substrate and magnetically divide the magnetic tracks in the radial direction of the substrate, the magnetic tracks being configured so that the magnetic occupancy of the data region pattern is 65% or more.

5. The magnetic disk according to claim 4, wherein each of the servo region patterns has a repetitive pattern region which is substantially radially continuous at least in the radial direction of the substrate and includes magnetic and nonmagnetic portions arranged alternately in the circumferential direction of the substrate, the magnetic occupancy of the repetitive pattern region of the servo region pattern being about 50%, a circumferential length of the repetitive pattern region along the circumferential direction of the substrate being 0.01 mm or more.

6. A magnetic disk apparatus comprising:
a magnetic disk according to claim 1;
a drive unit which supports the magnetic disk and rotates it at a predetermined speed;
a head which performs information processing for the magnetic disk; and
a head actuator which moves the head in a radial direction with respect to the magnetic disk.

7. The magnetic disk apparatus according to claim 6, wherein the magnetic disk is arranged such that the magnetic tracks of the data recording region and the recognition tracks of the landing region are located concentrically with the center of rotation of the drive unit.

8. A magnetic disk apparatus comprising:
a magnetic disk according to claim 2;
a drive unit which supports the magnetic disk and rotates it at a predetermined speed;
a head which performs information processing for the magnetic disk; and
a head actuator which moves the heads in a radial direction with respect to the magnetic disk.

9. A magnetic disk apparatus according to claim 8, wherein the magnetic disk is arranged such that the magnetic tracks of the data recording region and the recognition tracks of the landing region are located concentrically with the center of rotation of the drive unit.
